(19) United States
(12) Patent Application Publication
(10) Pub. No.: US 2006/0156873 A1
(43) Pub. Date: Jul. 20, 2006

(54) Wrench and fitting stand

(76) Inventor: Chris Ruiz, Julian, CA (US)

Correspondence Address: Karl M. Steins;Steins & Associates, Suite 120, 2333 Camino del Rio South, San Diego, CA, 92108, US

(21) Appl. No.: 11/037,785

(22) Filed: Jan. 18, 2005

(51) Int. Cl. B25B 23/00

(52) U.S. Cl. 81/462

(57) ABSTRACT

A Wrench and Fitting Stand is disclosed. The stand enables a user to securely hold the head or handle end of a conventional pipe wrench. A particularly important feature is that the stand makes it easy to manipulate the adjustment knob of the wrench while the wrench is being held in the stand. The stand is further be configured so that it can be rested without attachment on any flat surface, or alternatively it is permanently attachable to an external structure.

### BACKGROUND OF THE INVENTION

1. Field of the Invention

This invention relates generally to tools and fixtures and, more specifically, to a Wrench and Fitting Stand.

2. Description of Related Art

Adjustable wrenches, such as pipe and crescent wrenches are a mainstay in virtually every toolbox. Their adjustability provides particular utility that is virtually unequalled in its variety of applications, particularly when working with plumbing fittings and pipe. Professional plumbers and other tradespersons have in fact found that an adjustable wrench can be used in the field in place of a vise for holding a workpiece. In order to leave a hand free, the wrench is laid with its jaws pointed up, the workpiece is placed within it, and the jaws are tightened around the workpiece.

There are a couple of problems with this approach. First, the wrench is fairly unstable when used in this manner, and while it can be workable when working on a hard, flat surface (such as a bench), it is not a useful when the work surface is irregular. Second, it can be difficult to gain good leverage over the wrench, with the user typically having to try to pinch the wrench handle between his or her knees.

The device of FIGS. 1A and 1B was created presumably to address the aforementioned problems. FIGS. 1A and 1B are perspective and top views of a conventional pipe wrench stand that is the subject of Young, U.S. Pat. Nos. D371, 505 and 5,791,213.

The Young pipe wrench stand 10 has a base 11 defined by a recessed center section 26 and a channel 25 cut or formed within it. A fixed vertical support 12 is a flat plate that extends upwardly from the base 11. A movable vertical support 15 is an “L” shaped that slides back and forth in the channel 25, and can be held in a desired position clamping a pipe wrench head by a wing nut 22 that can be tightened against the movable vertical support 15.

While the Young device 10 does provide the user with better leverage than a stand-alone wrench, it still does not provide superior holding and stability, nor does it present the wrench in the most convenient and usable configuration. What is needed, then, is a stand for holding wrenches that provides these additional attributes.

### SUMMARY OF THE INVENTION

In light of the aforementioned problems associated with the prior games and devices, it is an object of the present invention to provide a Wrench and Fitting Stand. The stand should enable a user to securely hold the head or handle end of a conventional pipe wrench. It is particularly important that the stand make it easy to manipulate the adjustment knob of the wrench while the wrench is being held in the stand. The stand should further be configured so that it can be rested without attachment on any flat surface, or alternatively it should be permanently attachable to an external structure.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIGS. 1A and 1B are perspective and top views of a conventional pipe wrench stand;

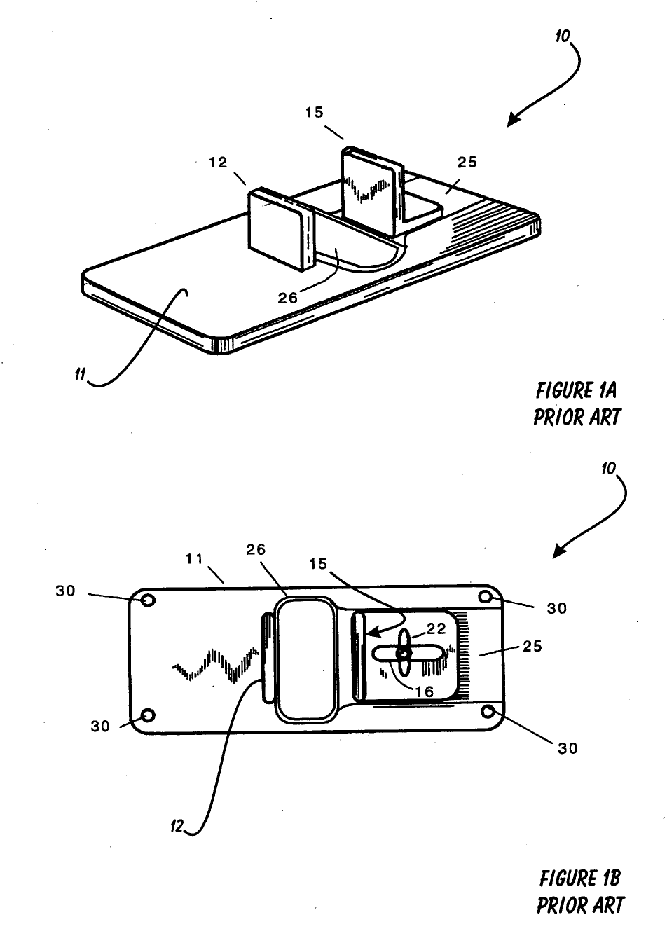

FIG. 2 is a perspective view of a preferred embodiment of the wrench and pipe stand of the present invention;

FIG. 3 is a front view of the stand of FIG. 2;

FIG. 4 is a side view of the stand of FIGS. 2 and 3; and

FIG. 5 is a perspective view of the stand of FIGS. 2-4 holding a pipe wrench.

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein specifically to provide a Wrench and Fitting Stand.

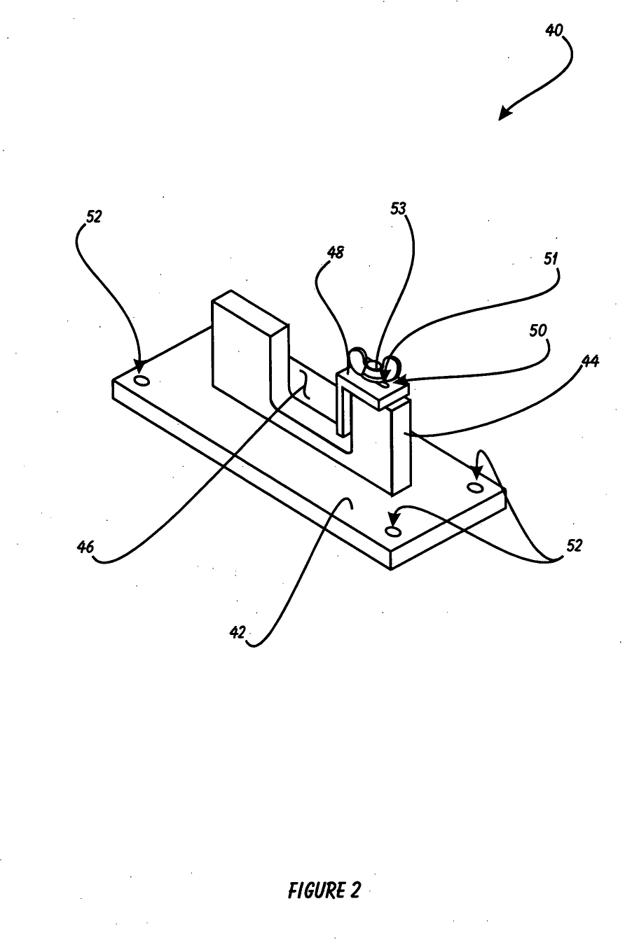

The present invention can best be understood by initial consideration of FIG. 2. FIG. 2 is a perspective view of a preferred embodiment of the wrench and pipe stand 40 of the present invention. The stand 40 has a flat base 42, preferably formed from steel or other durable material of approximately one-half inch in thickness. The base 42 preferably has apertures 52 cut through it adjacent to its comers. These apertures 52 make it easy to bolt or screw the stand 40 to a bench, board and the like.

A stand 44 member extends rigidly upward from the base 42. The stand 44 is made from flat material of approximately three-quarter inch in thickness. A cradle 46 is formed in the stand 44 for retaining a wrench or plumbing fitting therein. There is an L-shaped clamp 48 that has an elongated slot 51 cut through it. A specialized bolt 53 threadedly engages the stand 44 and through the slot 51. The bolt 53 has a wing-shaped head and a threaded post extending downwardly from it. The bolt 53 can be tightened down onto the clamp 48 after it is slid into its desired position to hold the wrench or fitting. The is also an externally-toothed lock washer between the head of the bolt 53 and the clamp 48.

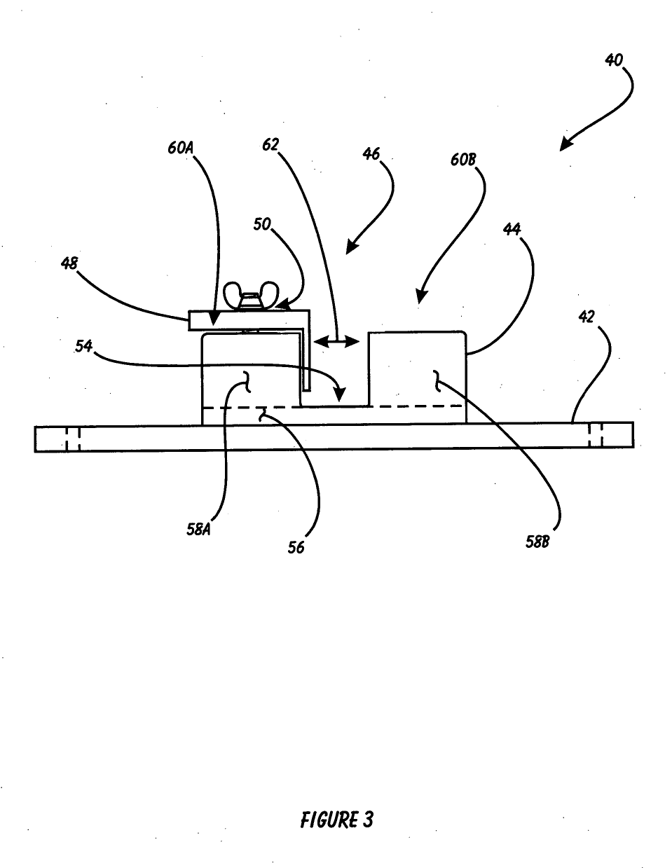

Having acquired an initial understand of the invention, we will now turn to FIG. 3 to continue exploring this useful device.

FIG. 3 is a front view of the stand 40 of FIG. 2. As shown here, the stand 44 defines a U-shape around the cradle 46. The width of the mouth 62 of the cradle 46 can be made adjusted by adjusting the position of the clamp 48. The stand 44 is formed from an intermediate segment 56 that forms the bottom portion of the stand 44, including the base surface 54 of the cradle. A first upright arm 58A and second upright arm 58B complete the “U” shape of the stand 44. Top surfaces 60A and 60B of the arms 58 are flat, with the first arm top surface 60A supporting the clamp 48.

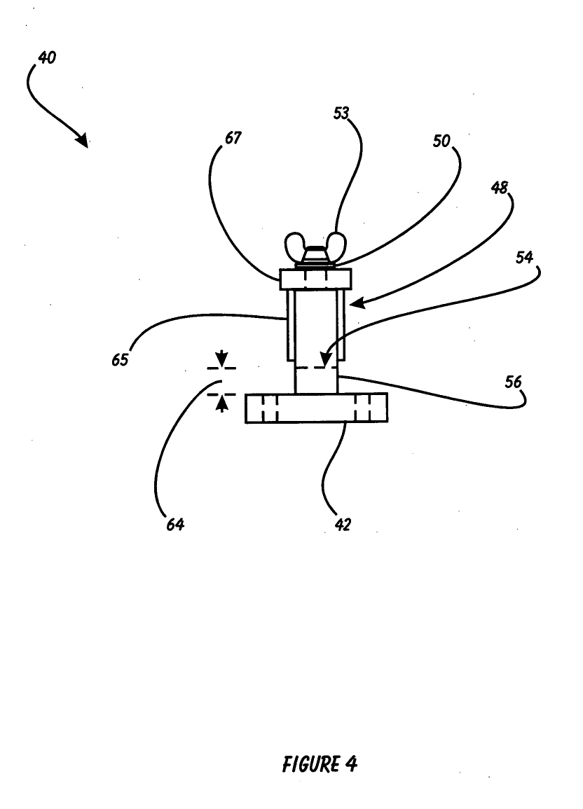

It is a critical feature that the upright arms 58 are fixed and rigid. Unlike the Young device, these rigid immovable arms provide, superior strength, durability and stability in holding a wrench. The cradle 48 will hold the wrench securely even if the clamp 48 is not very tightly pinched against it; it is not believed that the Young device will provide the same stability. FIG. 4 provides additional information about this invention.

FIG. 4 is a side view of the stand 40 of FIGS. 2 and 3. As can be seen here, the horizontal tab 67 and vertical tab 65 are both wider than the stand 44 is thick; this adds to the stabilizing capacity of the clamp 48. One other particularly important feature of this unique stand 40 relates to the standoff height 64 incorporated into the stand 40. The standoff height 64 is that distance of separation between the cradle base surface 54 (shown in hidden lines here) and the top surface of the base 42. Unlike the Young device, which has a recessed portion for the head of the wrench, the present invention actually raises the head of the wrench above the handle when the wrench is being held in the stand 40. Raising the wrench head above the handle is particularly valuable when working with a pipe wrench. As will be shown in the next drawing figure, in order to adjust pipe wrench, the user must have access to the back-side of the head of the wrench; the standoff height 64 provides the user with this ability.

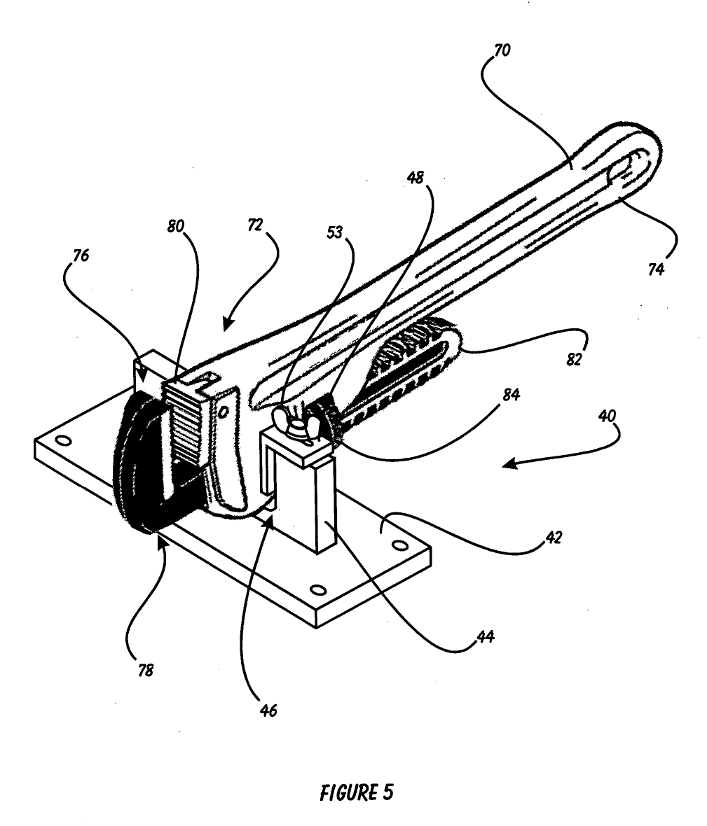

FIG. 5 is a perspective view of the stand 40 of FIGS. 2-4 holding a pipe wrench 70. In the typical configuration, the wrench 70 has a long handle 74 on one end and a head 72 at its other end. The head 72 has a mouth 76 with a fixed jaw 80 and a movable jaw 78. The movable jaw 78 has a worm screw 82 extending from it. The extended length of the worm screw (and therefore the size of the mouth 76) can be adjusted by rotating the adjustment knob 84 that engages the worm screw 82.

As should be clear in this view, the standoff height (see FIG. 4) proves a space between the adjustment knob 84 and the base 42; this makes the adjustment knob 84 easily accessible when first placing an item into the wrench, or further when releasing it from being held therein. The function of the clamp 48 is to keep the wrench 70 stable when using it to hold onto a workpiece. If additional leverage or stability is desired, the user can kneel or stand on the handle 74 and/or base 42.

One other benefit of the stand 44 of the present invention is that its compact size and shape makes it able to use for holding the handle 74 of the wrench, and not just the head 72. This can be particularly important in cases where larger objects are being held in the wrench and/or when a second wrench is being used on the held object.

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

1. A stand for wrenches or plumbing fittings, comprising:
a substantially flat base;
a stand extending upwardly from said base, said stand comprising:
an intermediate portion extending upwardly from said base and defining a cradle base surface opposite and in spaced relation above said base;
a first upright arm extending upwardly from said intermediate portion;
a second upright arm extending upwardly from said intermediate portion, said first and second upright arms are fixed and immovable in relation to said base; and
a clamp slidingly attached to a top surface of said first upright arm, said clamp defining an L-shape having a vertical tab extending downwardly towards said intermediate portion from a horizontal tab.

2. (canceled)

3. The stand of claim 1, wherein said upright arms and said intermediate portion form a cradle defined on its bottom side by a cradle base surface, said first upright arm further defining a top surface.

4. The stand of claim 3, further comprising a clamp slidingly attached to said top surface of said first upright arm, said clamp defining an L-shape having a vertical tab extending downwardly from a horizontal tab.

5. The stand of claim 4, wherein said horizontal tab is further defined by an elongate slot formed therethrough, said slot configured to accept a bolt extending downwardly therethrough to threadedly engage said first upright arm.

6. The stand of claim 5, wherein said base and said stand each define substantially flat profiles having uniform thickness over each of their respective spans.

7. A stand assembly, comprising:
a base defining a top surface;
a stand extending upwardly from said base, said stand comprising:
a pair of opposing upright arms in generally parallel spaced relation, said arms being fixed and immovable in relation to said base; and
a cradle located between said arms and further defined by a base surface, said base surface being spaced above said base top surface by a distance greater than zero; and
a clamp slidingly attached to a top surface of one said unright arm, said clamp defining an L-shape having a vertical tab extending downwardly into said cradle from a horizontal tab.

8. (canceled)

9. The stand assembly of claim 7, further comprising a clamp slidingly attached to a top surface of a first said upright am said clamp defining an L-shape having a vertical tab extending downwardly from a horizontal tab.

10. The stand assembly of claim 9, wherein said horizontal tab is further defined by an elongate slot formed therethrough, said slot configured to accept a bolt extending downwardly therethrough to engage a threaded bore formed in said first upright arm.

11. The stand assembly of claim 10, wherein said horizontal tab is positioned flat atop said top surface of said first upright arm, and said vertical tab extends downwardly into said cradle generally parallel to said first upright arm.

12. The stand assembly of claim 11, wherein said spacing between said cradle base surface and said base top surface is greater than 0.1 inches and less than 1.0 inches.

13. A wrench stand, comprising:
a flat rectangular base defining a first planar orientation and a center section;
a stand extending upwardly from said center section of said base, said stand defining a second planar orientation, said second planar orientation being perpendicular to said first planar orientation, said stand defining a cradle formed therein and a pair of fixed upright arms, said cradle and said fixed upright arms being fixed and immovable in relation to said base; and
a clamp slidingly engaging one said upright arm, said camp defining an L-shape having a vertical tab extending downwardly towards said cradle from a horizontal tab.

14. (canceled)

15. The stand of claim 13, further comprising a clamp slidingly attached to a top surface of a first said upright arm, said clamp defining an L-shape having a vertical tab extending downwardly from a horizontal tab.

16. The stand of claim 15, wherein said horizontal tab is further defined by an elongate slot formed therethrough, said slot configured to accept a bolt extending therethrough to engage a threaded bore formed in said first upright arm.

17. The stand of claim 16, wherein said horizontal tab is positioned flat atop said top surface of said first upright am and said vertical tab extends downwardly into said cradle generally parallel to said first upright arm.

18. The sand of claim 17, wherein said spacing between said cradle base surface and said base top surface is greater than 0.1 inches and less than 1.0 inches.

19. The stand of claim 18, wherein said stand is formed from a plate of material between 0.25 and 1.0 inches thick and defining flat opposing sides.

20. The stand of claim 19, wherein said base is formed from plate of material between 0.25 and 1.0 inches thick and defining flat upper and lower surfaces.
